(19) United States
(12) Patent Application Publication
(10) Pub. No.: US 2026/0159083 A1
(43) Pub. Date: Jun. 11, 2026

(54) SMART CRUISE CONTROL SYSTEM AND METHOD FOR MANUAL TRANSMISSION VEHICLE, PROGRAM, AND COMPUTER-READABLE RECORDING MEDIUM

(71) Applicants: Hyundai Motor Company, Seoul (KR); Kia Corporation, Seoul (KR)

(72) Inventor: Yong Dal LEE, Hwaseong-Si (KR)

(21) Appl. No.: 19/293,777

(22) Filed: Aug. 7, 2025

(30) Foreign Application Priority Data
Dec. 9, 2024 (KR) 10-2024-0181504

(51) Int. Cl. B60W 30/14; B60W 10/10; B60W 10/188; B60W 50/14

(52) U.S. Cl. CPC B60W 30/143; B60W 10/10; B60W 10/188; B60W 50/14; B60W 2050/146; B60W 2420/408; B60W 2510/0225; B60W 2510/0241; B60W 2510/0638; B60W 2510/0657; B60W 2520/105; B60W 2554/4042; B60W 2554/802

(57) ABSTRACT

An apparatus of a vehicle may comprise a cruise control circuit configured to receive a clutch pedal signal and gear position signals, wherein the clutch pedal signal indicates a position of a clutch pedal of the vehicle, and wherein the gear position signals indicate that a manual transmission of the vehicle is in reverse or neutral gear, an electronic stability controller (ESC) circuit configured to receive a stroke signal from a clutch pedal stroke sensor to control braking of the vehicle, an engine electronic control circuit configured to receive input from the manual transmission, a processor, and a memory storing at least one instruction that, when executed by the processor communicating with the memory, is configured to cause the apparatus to determine a torque associated with the vehicle, output a control signal, and control vehicle operation.

### CROSS-REFERENCE TO RELATED APPLICATION

This present application claims the benefit of priority to Korean Patent Application No. 10-2024-0181504, filed in the Korean Intellectual Property Office on Dec. 9, 2024, the entire contents of which are incorporated herein by reference.

### TECHNICAL FIELD

The present disclosure relates to a smart cruise control (SCC) system and method for a manual transmission (MT) vehicle, and more particularly, to an SCC system and method for an MT vehicle that maintain a distance between vehicles and a speed based on a speed of a forward vehicle and a set distance of a driver for an MT vehicle.

### BACKGROUND

The matters described in this Background section are only for enhancement of understanding of the background of the disclosure, and should not be taken as acknowledgment that they correspond to prior art already known to those skilled in the art.

Examples of a transmission of a vehicle include an automatic transmission, an MT, and a continuously variable transmission (CVT). Among these transmissions, an MT vehicle may not have an SCC device that maintains a set distance of a driver according to a speed of a forward vehicle. Instead, a driver may manually control an accelerator pedal to maintain speed and alternately operate the accelerator pedal and a brake pedal to maintain a distance from the forward vehicle and prevent collision.

In this instance, it is inconvenient to maintain the speed and distance between vehicles by operating the accelerator pedal and brake pedal, and the driver may feel tired after driving for a long time. In addition, it may be unsafe since it is not practically possible to control an appropriate distance between vehicles according to a driving speed. Therefore, it may not satisfy basic functions (e.g., related to safety performance of vehicles) required by organizations such as European New Car Assessment Programme (EURO NCAP), etc.

### SUMMARY

Accordingly, the present disclosure is directed to a smart cruise control system and method for a manual transmission vehicle, a program, and a computer-readable recording medium that substantially obviate one or more problems.

The present disclosure is intended to solve the above-mentioned problems, and an object of the present disclosure is to provide an SCC system and method for an MT vehicle capable of controlling a speed with respect to a forward vehicle and a driver-set distance by automatically accelerating and decelerating the MT vehicle.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to the present disclosure, an apparatus of a vehicle, the apparatus may comprise a cruise control circuit configured to receive a clutch pedal signal and gear position signals, wherein the clutch pedal signal indicates a position of a clutch pedal of the vehicle, and wherein the gear position signals indicate that a manual transmission of the vehicle is in reverse or neutral gear, an electronic stability controller (ESC) circuit configured to receive a stroke signal from a clutch pedal stroke sensor to control braking of the vehicle, an engine electronic control circuit configured to receive input from the manual transmission, a processor, and a memory storing at least one instruction that, when executed by the processor communicating with the memory, is configured to cause the apparatus to, determine, based on the clutch pedal signal, the gear position signals, the stroke signal, and the input from the manual transmission, a torque associated with the vehicle, output a control signal indicating the torque associated with vehicle, and control, based on the control signal, operation of the vehicle.

The apparatus may further comprise a driving assistance button configured to input a driving assistance signal to the cruise control circuit.

The apparatus may further comprise a front radar configured to detect a signal of a forward vehicle and transmit the detected signal to the cruise control circuit.

The apparatus, wherein the cruise control circuit is configured to, based on input levels of the clutch pedal signal and the gear position signals, prevent activation of automatic speed control and deactivate previously activated automatic speed control.

The apparatus, wherein the cruise control circuit is configured to release, based on the clutch pedal being depressed for a threshold period of time or more, a cruise control of the vehicle.

The apparatus, wherein the cruise control circuit is configured to, determine, based on a situation of a forward vehicle, an acceleration value for the vehicle, and display, on a cluster of the vehicle, a cruise control state of the vehicle.

The apparatus, wherein the ESC circuit is configured to, generate, based on a required acceleration for the vehicle, an engine torque and a braking torque, wherein the torque may comprise the engine torque and the braking torque, and block, based on a clutch operation state of the vehicle, at least a portion of the engine torque.

The apparatus, wherein the ESC circuit is configured to, determine a required cruise control engine torque in an acceleration situation for the vehicle, and determine a braking torque required for deceleration of the vehicle in a deceleration situation for the vehicle, wherein the torque may comprise the required cruise control engine torque and the braking torque.

The apparatus, wherein the engine electronic control circuit is configured to, generate the required cruise control engine torque, determine a current gear stage of the vehicle, and control, based on the determined current gear stage, a gear stage shift of the vehicle.

The apparatus, wherein the engine electronic control circuit is configured to determine, based on a speed of the vehicle, an engine rotation speed of the vehicle, and the clutch pedal signal of the vehicle, the current gear stage of the vehicle.

The apparatus, wherein the engine electronic control circuit is configured to control the gear stage shift through a gear shift indicator.

According to the present disclosure, a method performed by an apparatus of a vehicle, the method may comprise generating, based on a clutch pedal of the vehicle being engaged, a required torque of a first magnitude, suspending, based on the clutch pedal being disengaged, generation of the required torque, and resuming, based on the clutch pedal being at least partially engaged, generation of the required torque by increasing a current torque value up to the first magnitude.

The method, wherein the increasing of the current torque value may comprise increasing the current torque value from zero or from a value less than the first magnitude to the first magnitude over a period of time.

The method, wherein the generating of the required torque may comprise turning on gear information about the vehicle, the resuming of generation of the required torque may comprise turning on the gear information, and the suspending of generation of the required torque may comprise turning off the gear information.

The method, wherein the suspending of generation of the required torque may comprise controlling a clutch slip state before and after the clutch pedal is disengaged, respectively, and wherein the clutch slip state corresponds to a condition in which the clutch pedal is partially engaged.

The method may further comprise determining, based on a requirement for constant speed driving of the vehicle and an acceleration required in a cruise control of the vehicle, an engine torque, wherein the vehicle is a manual transmission vehicle, and performing, based on the determined engine torque, constant speed driving of the vehicle.

The method may further comprise determining, based on a requirement for accelerated driving the vehicle and an acceleration required in a cruise control of the vehicle, an engine torque, wherein the vehicle is a manual transmission vehicle, and performing, based on the determined engine torque, accelerated driving of the vehicle.

The method may further comprise determining, based on a requirement for decelerated driving of the vehicle and an acceleration required in a cruise control of the vehicle, a braking torque, wherein the vehicle is a manual transmission vehicle, and performing, based on the determined braking torque, decelerated driving of the vehicle, wherein the determined braking torque corresponds to a hydraulic pressure associated with a brake of the vehicle.

According to the present disclosure, an apparatus for a vehicle, the apparatus may comprise a processor, and a memory storing at least one instruction that, when executed by the processor communicating with the memory, is configured to cause the apparatus to, obtain a pedal sensor signal indicating a position of a clutch pedal of the vehicle, obtain a gear sensor signal indicating whether a gear stage of the vehicle is in a reverse or neutral state, obtain data indicating a speed and distance of a preceding vehicle, based on the position of the clutch pedal of the vehicle, the gear stage of the vehicle, and the speed and distance of the preceding vehicle, determine a required acceleration or a required deceleration, based on the determined required acceleration or the determined required deceleration, determine an engine torque value or a braking torque value, respectively, output a signal indicating the determined engine torque value or a braking torque value, and control, based on the signal, operation of the vehicle.

The apparatus, wherein the at least one instruction, when executed by the processor communicating with the memory, is configured to cause the apparatus to, suspend, based on the clutch pedal being disengaged, the output of the signal indicating the determined engine torque value, and resume, based on the clutch pedal being at least partially engaged, the output of the signal by increasing a torque value from zero or a reduced value up to the determined engine torque value.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate example(s) of the disclosure and together with the description serve to explain the principle of the disclosure. In the drawings:

FIG. 1 shows an exemplary configuration of an SCC system for an MT vehicle according to an example of the present disclosure;

FIG. 2 shows an example of an SCC method for an MT vehicle according to another example of the present disclosure; and

FIG. 3 shows an exemplary effect of the present disclosure according to Euro NCAP 2026.

FIG. 4 shows an example computing system (a computing device of a smart cruise control (SCC) system or a vehicle or any other apparatus).

### DETAILED DESCRIPTION

Hereinafter, some examples of the present disclosure will be described in detail with reference to illustrative drawings. When adding reference numerals to components in each drawing, it should be noted that identical components are given the same reference numerals as much as possible even when the components are shown in different drawings. In addition, when describing examples of the present disclosure, when a specific description of a related known structure or function is determined to hinder understanding of the examples of the present disclosure, the detailed description will be omitted.

In the description of the examples according to the present disclosure, when an element is described as being formed “on or under” another element, the two elements may be directly in contact with each other or may be indirectly formed with one or more other elements disposed therebetween. In addition, when the expression “on or under” is used, a direction thereof may include a downward direction as well as an upward direction based on one element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

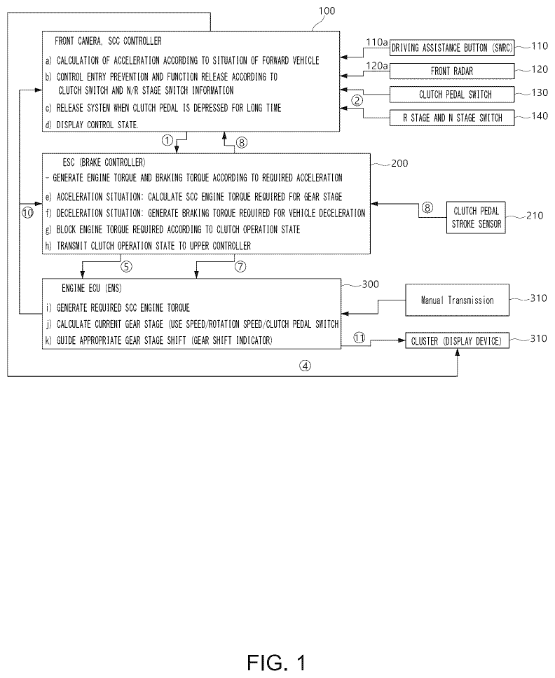

FIG. 1 shows an exemplary configuration for an SCC system of an MT vehicle according to an example of the present disclosure. Hereinafter, a description will be given of the SCC system implemented for the MT vehicle according to the example of the present disclosure with reference to FIG. 1.

The SCC system for the MT vehicle according to this example may include a front camera, an SCC controller 100, an electronic stability controller (ESC) (brake controller) 200, and an engine electronic control unit (ECU) (engine management system (EMS)) 300 (e.g., Bosch EMS, Delphi MT ECU, or similar systems, etc.).

The SCC controller 100 may perform a) calculating acceleration according to a situation of a forward vehicle, b) preventing control entry and releasing functions according to input levels of a clutch pedal signal and reverse (R) stage and neural (N) stage signals of a gear, c) disengaging SCC if a clutch pedal is depressed for a certain period of time or more, and d) displaying a control state (e.g., active cruise control, standby, fault state, or manual override, etc.).

The ESC 200 generates engine torque and braking torque according to required acceleration, also referred to as “body attitude control” , and may be a general term for functions of ABS (Antilock Braking System), TCS (Traction Control System), and ESC (Electronic Stability Controller). In detail, the ESC 200 e) calculates SCC engine torque required for a gear stage in an acceleration situation (e.g., when shifting from third to fourth gear, during highway merging, or while overtaking another vehicle, etc.), f) generates braking torque required for vehicle deceleration in a deceleration situation (e.g., approaching a red light, descending a slope, or responding to a slowing lead vehicle, etc.), g) blocks engine torque required according to a clutch operation state (e.g., when the clutch pedal is fully depressed, during gear disengagement, or in a neutral gear condition, etc.), and h) transmits the clutch operation state to an upper controller (e.g., to coordinate engine torque control, resume cruise logic, or manage torque interruption timing, etc.). Here, the upper controller may be the SCC controller 100 (e.g., a processor executing cruise control logic based on pedal and gear inputs, etc.).

The engine ECU (EMS) 300 i) generates required SCC engine torque (e.g., to maintain set cruising speed, respond to lead vehicle acceleration, or stabilize speed after gear engagement, etc.), and j) calculates a current gear stage (e.g., using vehicle speed, engine RPM, and clutch status, etc.). In this instance, a vehicle speed, a rotation speed, and a clutch pedal signal may be used (e.g., to infer gear position, detect driver intent, or validate shift timing, etc.). In addition, the engine ECU 300 may k) guide an appropriate gear stage shift through a gear shift indicator (e.g., LED shift prompt, dashboard message, or head-up display, etc.).

The detailed description is as follows. The SCC controller receives input of an image of a preceding vehicle acquired from a front camera, may receive input from a driving assistance button (SWRC) and a front radar (e.g., for detecting inter-vehicle distance, identifying cut-in vehicles, or enabling/disabling cruise control, etc.), and in particular, may receive input (2) of the clutch pedal signal and the R stage and N stage signals of the gear (e.g., to determine whether the vehicle is in reverse, neutral, or ready for forward engagement, etc.). In this instance, the driving assistance button may be selected and input when the driver desires to use the SCC controller 100 (e.g., if enabling cruise mode on the highway, in stop-and-go traffic, or during steady-state driving, etc.).

The SCC controller may receive inputs of the clutch pedal signal and the R stage and N stage signals of the gear (2), calculate acceleration according to a situation of the forward vehicle (e.g., slowing vehicle, sudden stop, or steady cruise, etc.), and transmit the acceleration to the ESC (1).

In addition, input (8) of a clutch pedal stroke sensor may be transmitted to the ESC 200 (e.g., to detect partial engagement, trigger torque cutoff, initiate deceleration control, or coordinate gear shift transitions, etc.), and the clutch operation state may be transmitted (h) to the SCC controller 100, which is the upper controller (e.g., to resume torque output, evaluate cruise re-engagement conditions, or synchronize with acceleration control logic, etc.).

In addition, a gear stage in the manual transmission may be calculated and input to the engine ECU 300 (e.g., by using vehicle speed, engine RPM, and clutch engagement signals to infer whether the vehicle is in second, third, or fourth gear, etc.), and the ESC 200 may transmit a calculated value (5) of the required SCC engine torque and a blocking signal (7) of the required engine torque based on the clutch operation state to the engine ECU 300 in response to the gear stage in the acceleration situation (e.g., when upshifting from third to fourth, recovering speed after a downshift, or accelerating in an optimal gear range, etc.).

The SCC controller 100 may transmit (4) display of the control state of the vehicle to a cluster (e.g., display device to display cruise activation, gear recommendation, system error, or standby mode, etc.). In addition, the engine ECU 300 may transmit (11) the shift to the appropriate gear stage to the cluster, and may calculate a current gear stage and transmit (10) the current gear stage to each of the SCC controller 100 and ESC 200 (e.g., to maintain synchronized control states across systems, etc.).

The SCC system of the MT vehicle according to the present disclosure may not include an automatic transmission control unit (TCU) (e.g., transmission logic hardware found in an automatic or DCT vehicles, etc.). However, a clutch pedal signal may be provided to check a clutch pedal operation state of the MT vehicle and the intention of the driver to shift gears (e.g., during take-off, gear transitions, or coasting, etc.), the N stage and R stage signals may determine that the gear is in neutral and reverse states, respectively (e.g., to block cruise control engagement, disable torque commands, or initiate safe fallback logic, etc.). The clutch pedal stroke sensor may determine control timing of the engine torque to determine a combination state of a clutch pedal stroke and a transmission clutch (e.g., distinguishing between full engagement, partial slip, or complete disengagement, etc.), and thus acceleration or deceleration of the vehicle may be possible in each gear stage in the MT vehicle. (e.g., first gear for hill starts, third gear for moderate cruise, or fifth gear for highway driving, etc.)

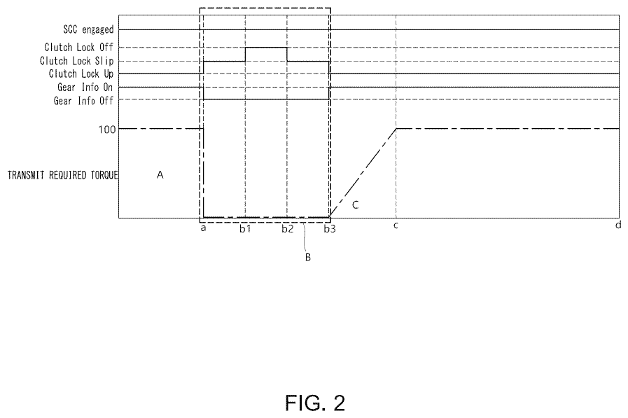

FIG. 2 shows an example of an SCC method for the MT vehicle according to another example of the present disclosure. Hereinafter, a description will be given of the SCC method for the MT vehicle according to the other example of the present disclosure.

A gear shifting method of the MT vehicle is basically the same as that of an AT (automatic transmission) vehicle. For example, when constant speed driving is required, required SCC torque may be calculated based on acceleration required by the SCC and transmitted to the ECU to perform constant speed driving (e.g., highway cruising, rural road driving, or urban arterial cruising, etc.). When accelerated driving is required, required SCC torque may be calculated based on acceleration required by the SCC and transmitted to the ECU to perform accelerated driving (e.g., overtaking, ramp merging, or lane changes, etc.). Further, when decelerated driving is required, braking torque may be calculated based on acceleration required by the SCC and may be calculated as target hydraulic pressure, etc. to perform deceleration (e.g., slowing for traffic, approaching a red light, or descending a hill, etc.).

Specifically, the SCC method for the MT vehicle may include a first step (A) of transmitting required torque of a first magnitude 100 while the clutch pedal is engaged (e.g., during steady cruising, after gear engagement, or under load-holding conditions, etc.), a second step (B) of stopping transmission of the required torque while the clutch pedal is disengaged (e.g., during gear shifting, clutch coasting, or temporary disengagement for manual override, etc.), and a third step (C) of increasing transmission of the required torque to the first magnitude when the clutch pedal is engaged again (e.g., after completing a gear shift, resuming cruise control, or exiting a stop condition, etc.).

The third stage may include a (3-1)th step in which the magnitude of the transmitted required torque gradually increases (e.g., ramping up from zero to cruising torque after gear engagement, etc.), and a (3-2)th step in which the required torque of the first magnitude is continuously transmitted (e.g., maintaining a steady driving state until the next clutch interaction, etc.). For example, the magnitude of the required torque transmitted in the (3-1)th step may increase from 0 to the first magnitude and increase to be the same as the magnitude of the required torque transmitted in the first step (e.g., gradually restoring cruise control after a gear shift, etc.).

In the first step and the third step, gear information may be turned on, and in the second step, the gear information may be turned off (e.g., to reflect clutch disengagement and shifting uncertainty, etc.).

In the second step, a clutch slip state may be implemented before and after the clutch is disengaged, respectively (e.g., during clutch travel or incomplete pedal release, etc.).

Here, the SCC method for the MT vehicle has differences as shown in FIG. 2.

In FIG. 2, “SCC engaged” indicates that the vehicle is controlled by SCC throughout the entire section, a clutch engaged state indicates that the driver releases the clutch pedal (e.g., allowing full engine-to-transmission power delivery, after gear selection, or during steady-state driving, etc.), a clutch disengaged state indicates that the driver depresses the clutch pedal (e.g., to interrupt engine power, initiate a gear shift, or coast without load, etc.), and a clutch lock slip state indicates that the engine and the transmission are appropriately slipping (e.g., during partial clutch engagement for smooth torque transition, etc.).

If the other control conditions of SCC are satisfied and the clutch pedal is in the clutch engaged state, for example, if the driver releases the clutch pedal, the ESC requests generation of engine torque. Even when all other control conditions of SCC are satisfied, if the clutch pedal is in the clutch disengaged state, for example, if the driver depresses the clutch pedal, the ESC blocks the engine torque and appropriately transmits the required torque of the SCC controller to the engine ECU so that output may be controlled (e.g., to ensure safe shifting without unintended acceleration, etc.).

For example, in FIG. 2, if a control condition for an appropriate gear stage or higher is satisfied, constant speed driving or accelerated driving may be performed by calculating engine torque suitable for the required acceleration (e.g., maintaining cruise in fourth gear, accelerating in third gear, or resuming cruise after a downshift, etc.). Further, if the gear stage is inappropriate, it is possible to wait for a certain period of time or perform release (e.g., if the gear is too low for cruising or too high for torque demand, etc.).

In particular, if the driver depresses the clutch pedal during SCC control, for example, if the clutch is disengaged (e.g., to initiate a gear change, temporarily interrupt torque, or prepare for a stop, etc.), transmission of the required SCC torque is immediately suspended when the required SCC torque is being transmitted. If the clutch pedal is released, required engine torque necessary for control is immediately requested from the ECU (e.g., to resume cruise speed, stabilize acceleration, or maintain following distance, etc.). In this instance, even when the driver depresses the clutch pedal, if the vehicle is in a deceleration situation, deceleration control may be continued (e.g., engine braking on a downhill slope, slowing in traffic, or approaching a stop sign, etc.). In addition, the ESC may transmit or block the required SCC torque depending on the state of the clutch pedal (e.g., distinguishing between steady cruise, downshifting, or coasting conditions, etc.).

For example, in FIG. 2, SCC control continues, and in the clutch engaged state (sections A and C) where the driver releases the clutch pedal, gear information is turned on (Gear Info on), for example, the current gear stage may be displayed on the cluster, etc. In the clutch disengaged state where the driver depresses the clutch pedal, the gear information is turned off (Gear Info off, sections b1 to b2), for example, since the gear may be shifted, the current gear stage is not displayed on the cluster, etc. In addition, if the gear information changes from on to off or from off to on, the clutch lock slip state (sections a to b1, sections b2 to b3) progresses in the middle so that the engine and transmission may appropriately slip (e.g., avoiding torque shock, synchronizing input/output shafts, etc.).

In addition, in section A, the required torque (first magnitude, 100) is transmitted according to SCC control (e.g., during steady cruising, after gear engagement, or under stable driving conditions, etc.), in section B indicated by a dotted line, the clutch pedal is depressed and the engine torque transmission is suspended (e.g., to allow gear shifting, prevent surge, or avoid unintended acceleration, etc.), and in section C after the clutch pedal is no longer depressed, transmission of the required torque increases to a certain magnitude (first magnitude, 100) for a certain period of time (up to point c) (e.g., to smoothly reapply drive force, maintain ride comfort, or avoid drivetrain shock, etc.), and then the required torque of the same magnitude may be continuously transmitted (e.g., to ensure smooth re-engagement of cruise speed after gear shifting, etc.).

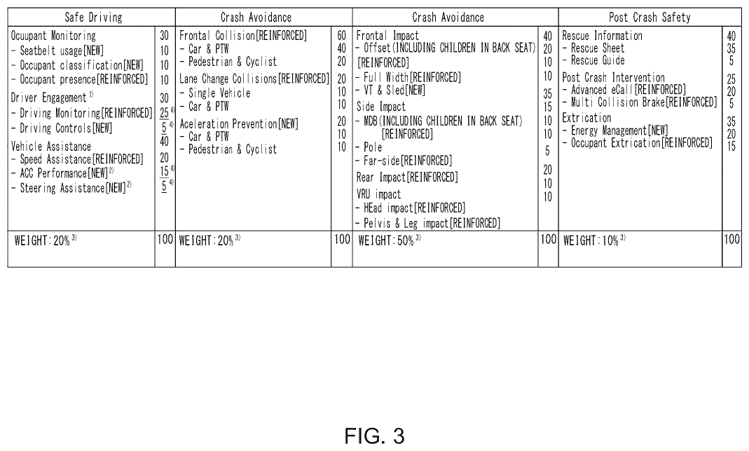

FIG. 3 shows an exemplary effect of the present disclosure according to Euro NCAP 2026.

Here, Safe Driving, Crash Avoidance, Crash Protection, and Post-Crash Safety have weights of 20%, 20%, 50%, and 10%, respectively (e.g., reflecting the relative importance of preventive features, impact mitigation, and post-collision response in overall vehicle safety scoring, etc.).

In addition, 1) Driver Engagement may be penalized if performance of maintaining a driving intervention state of the driver in an AD system (Assisted Driving, ex: HDA II) evaluation is poor, and 2) Vehicle Assistance is an Adaptive Cruise Control (ACC) (accessory)/Steering (STRG) assist Function evaluation, and in order to obtain points, ACC is provided as a basic feature, provided alone or as part of the AD system, and Steering assist needs to be provided as a basic feature within ACC (e.g., for lane centering, corner following, or automated merge support, etc.).

3) Weighting for each step is only reflected in score calculation for selecting the Best Car for each vehicle class in the current year (e.g., compact car, midsize SUV, electric hatchback, or commercial van, etc.), and 4) in a final version of FIG. 3, score distribution of some sub-items was adjusted compared to the draft (e.g., rebalancing between driver monitoring, ACC performance, and steering assist weightings, etc.). In Driver Engagement, driving monitoring was adjusted from 20 points to 25 points, driving control was adjusted from 10 points to 5 points, and in Vehicle Assistance, ACC performance was adjusted from 10 points to 15 points, and Steering Assistance was adjusted from 10 points to 5 points (e.g., reflecting shifting priorities toward driver alertness and longitudinal control performance, etc.).

In addition, 5) Intelligent Speed Limitation function based on SCC is required to get a high score in Speed Assistance, and 6) Adaptive Cruise Control is required as standard equipment in SCC Performance (e.g., to comply with Euro NCAP 2026 baseline scoring requirements, etc.).

According to the SCC system and method for the MT vehicle of the present disclosure, by applying SCC, which is an assisted driving method, to the MT vehicle, a speed and distance may be adjusted without continuous intervention of the driver (e.g., maintaining following distance in traffic, cruising at highway speed, or slowing in response to a leading vehicle, etc.), and as described above, the EURO NCAP product quality may be improved (e.g., by satisfying safety assist feature requirements for Speed Assistance and Adaptive Cruise Control, etc.). In particular, points may be awarded for speed assistance and ACC performance among the evaluation items of EURO NCAP (e.g., contributing to higher Safety Assist and Driver Assistance category scores, etc.).

According to the SCC system and method for the MT vehicle of the present disclosure, by applying SCC, which is an assisted driving method, to the MT vehicle, a speed and distance may be adjusted without continuous pedal intervention of the driver, and as described above, the EURO NCAP product quality may be improved (e.g., through enhanced compliance with evolving ADAS benchmarks, etc.).

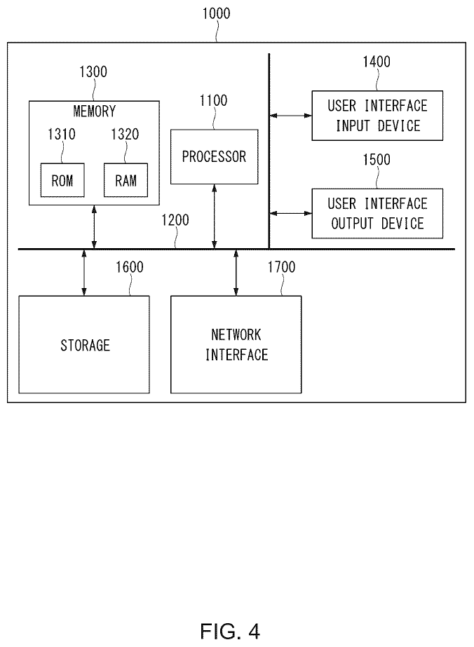

FIG. 4 shows an example computing system (e.g., a computing device of a smart cruise control (SCC) system or a vehicle or any other apparatus). One or more controllers, processors, etc. described herein, such as one or more components of the SCC system, one or more components of the vehicle, and any other components and devices disclosed herein, may be implemented by or in the computing system as shown in FIG. 4.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

To achieve above objects and other advantages and in accordance with the purpose of the disclosure, as exemplified and broadly described herein, a smart cruise control (SCC) system for a manual transmission (MT) vehicle includes an SCC controller configured to receive input of a clutch pedal signal and R and N stage signals of a gear, an electronic stability controller (ESC) configured to receive input of a clutch pedal stroke sensor to brake the vehicle, and an engine electronic control unit (EMS) configured to receive input of an MT.

The SCC system may further include a driving assistance button configured to input a driving assistance signal to the SCC controller, and may further include a front radar configured to detect a signal of a forward vehicle and transmit the signal to the SCC controller.

The SCC controller may perform control entry prevention and function release according to input levels of the clutch pedal signal and the R and N stage signals of the gear.

The SCC controller may release SCC if a clutch pedal is depressed for a certain period of time or more.

The SCC controller may calculate acceleration according to a situation of a forward vehicle and display an SCC state on a cluster.

The ESC may generate engine torque and braking torque according to required acceleration, block required torque according to a clutch operation state, or transmit the clutch operation state to an upper controller.

The ESC may calculate required SCC engine torque in an acceleration situation, and generate braking torque required for deceleration of the vehicle in a deceleration situation.

The ESC may generate required engine torque required by the ESC, calculate a current gear stage, and guide an appropriate gear stage shift.

The engine ECU may calculate the current gear stage using a speed of the vehicle, an engine rotation speed, and a clutch pedal signal.

The engine ECU may guide the appropriate gear stage shift through a gear shift indicator.

In another example of the present disclosure, an SCC method for an MT vehicle includes transmitting required torque of first magnitude while a clutch pedal is engaged, suspending transmission of the required torque while the clutch pedal is disengaged, and increasing transmission of the required torque up to the first magnitude until the clutch pedal is engaged again.

The increasing may include increasing the suspended transmission of the required torque, and continuously transmitting the required torque of the first magnitude.

Gear information may be turned on in the transmitting and the increasing, and the gear information may be turned off in the suspending.

The suspending may include implementing a clutch slip state before and after the clutch is disengaged, respectively.

When constant speed driving of the MT vehicle is required, required SCC torque may be calculated based on acceleration required in SCC, and the calculated required SCC torque may be transmitted to an ECU to perform constant speed driving.

When accelerated driving of the MT vehicle is required, required SCC torque may be calculated based on acceleration required in SCC, and the calculated required SCC torque may be transmitted to an ECU to perform accelerated driving.

When decelerated driving of the MT vehicle is required, braking torque may be calculated based on acceleration required in SCC, and the calculated braking torque may be calculated as target hydraulic pressure and transmitted to an ECU.

In another example of the present disclosure, a program is recorded on a computer-readable recording medium, wherein the SCC method for the MT vehicle according to the examples is executed by a processor.

In another example of the present disclosure, a computer-readable recording medium stores the program described above.

In the above description, even though all the components included in the examples of the present disclosure have been described as being combined into one or operating in combination, the present disclosure is not necessarily limited to these examples. For example, within the scope of the purpose of the present disclosure, all of the components may be selectively combined into one or more and operated. In addition, the terms “include”, “comprise”, or “have” described above, unless specifically stated to the contrary, mean that the corresponding components may be included, and therefore should be interpreted to include other components rather than excluding other components. All terms, including technical or scientific terms, unless defined otherwise, have the same meaning as commonly understood by a person of ordinary skill in the art to which the present disclosure pertains. Commonly used terms, such as terms defined in dictionaries, should be interpreted as consistent with meanings thereof in the context of the relevant art, and will not be interpreted in an idealized or overly formal sense, unless explicitly defined in the present disclosure.

The above description is only an illustrative example of the technical idea of the present disclosure, and those skilled in the art to which the present disclosure pertains may make various modifications and variations without departing from the essential characteristics of the present disclosure. Accordingly, the examples published in the present disclosure are not intended to limit the technical idea of the present disclosure but to describe the technical idea, and the scope of the technical idea of the present disclosure is not limited by these examples. The scope of protection of the present disclosure should be interpreted by the claims below, and all technical ideas within a scope equivalent thereto should be interpreted as being included in the scope of rights of the present disclosure.

What is claimed is:

1. An apparatus of a vehicle, the apparatus comprising:
a cruise control circuit configured to receive a clutch pedal signal and gear position signals, wherein the clutch pedal signal indicates a position of a clutch pedal of the vehicle, and wherein the gear position signals indicate that a manual transmission of the vehicle is in reverse or neutral gear;
an electronic stability controller (ESC) circuit configured to receive a stroke signal from a clutch pedal stroke sensor to control braking of the vehicle;
an engine electronic control circuit configured to receive input from the manual transmission;
a processor; and
a memory storing at least one instruction that, when executed by the processor communicating with the memory, is configured to cause the apparatus to:
determine, based on the clutch pedal signal, the gear position signals, the stroke signal, and the input from the manual transmission, a torque associated with the vehicle;
output a control signal indicating the torque associated with vehicle; and
control, based on the control signal, operation of the vehicle.

2. The apparatus according to claim 1, further comprising a driving assistance button configured to input a driving assistance signal to the cruise control circuit.

3. The apparatus according to claim 1, further comprising a front radar configured to detect a signal of a forward vehicle and transmit the detected signal to the cruise control circuit.

4. The apparatus according to claim 1, wherein the cruise control circuit is configured to, based on input levels of the clutch pedal signal and the gear position signals, prevent activation of automatic speed control and deactivate previously activated automatic speed control.

5. The apparatus according to claim 1, wherein the cruise control circuit is configured to release, based on the clutch pedal being depressed for a threshold period of time or more, a cruise control of the vehicle.

6. The apparatus according to claim 1, wherein the cruise control circuit is configured to:
determine, based on a situation of a forward vehicle, an acceleration value for the vehicle, and
display, on a cluster of the vehicle, a cruise control state of the vehicle.

7. The apparatus according to claim 1, wherein the ESC circuit is configured to:
generate, based on a required acceleration for the vehicle, an engine torque and a braking torque, wherein the torque comprises the engine torque and the braking torque, and
block, based on a clutch operation state of the vehicle, at least a portion of the engine torque.

8. The apparatus according to claim 1, wherein the ESC circuit is configured to:
determine a required cruise control engine torque in an acceleration situation for the vehicle, and
determine a braking torque required for deceleration of the vehicle in a deceleration situation for the vehicle, wherein the torque comprises the required cruise control engine torque and the braking torque.

9. The apparatus according to claim 8, wherein the engine electronic control circuit is configured to:
generate the required cruise control engine torque,
determine a current gear stage of the vehicle, and
control, based on the determined current gear stage, a gear stage shift of the vehicle.

10. The apparatus according to claim 9, wherein the engine electronic control circuit is configured to determine, based on a speed of the vehicle, an engine rotation speed of the vehicle, and the clutch pedal signal of the vehicle, the current gear stage of the vehicle.

11. The apparatus according to claim 9, wherein the engine electronic control circuit is configured to control the gear stage shift through a gear shift indicator.

12. A method performed by an apparatus of a vehicle, the method comprising:
generating, based on a clutch pedal of the vehicle being engaged, a required torque of a first magnitude;
suspending, based on the clutch pedal being disengaged, generation of the required torque; and
resuming, based on the clutch pedal being at least partially engaged, generation of the required torque by increasing a current torque value up to the first magnitude.

13. The method according to claim 12, wherein the increasing of the current torque value comprises:
increasing the current torque value from zero or from a value less than the first magnitude to the first magnitude over a period of time.

14. The method according to claim 12, wherein:
the generating of the required torque comprises turning on gear information about the vehicle,
the resuming of generation of the required torque comprises turning on the gear information, and
the suspending of generation of the required torque comprises turning off the gear information.

15. The method according to claim 12, wherein the suspending of generation of the required torque comprises controlling a clutch slip state before and after the clutch pedal is disengaged, respectively, and wherein the clutch slip state corresponds to a condition in which the clutch pedal is partially engaged.

16. The method according to claim 12, further comprising:
determining, based on a requirement for constant speed driving of the vehicle and an acceleration required in a cruise control of the vehicle, an engine torque, wherein the vehicle is a manual transmission vehicle; and
performing, based on the determined engine torque, constant speed driving of the vehicle.

17. The method according to claim 12, further comprising:
determining, based on a requirement for accelerated driving the vehicle and an acceleration required in a cruise control of the vehicle, an engine torque, wherein the vehicle is a manual transmission vehicle; and
performing, based on the determined engine torque, accelerated driving of the vehicle.

18. The method according to claim 12, further comprising:
determining, based on a requirement for decelerated driving of the vehicle and an acceleration required in a cruise control of the vehicle, a braking torque, wherein the vehicle is a manual transmission vehicle; and
performing, based on the determined braking torque, decelerated driving of the vehicle, wherein the determined braking torque corresponds to a hydraulic pressure associated with a brake of the vehicle.

19. An apparatus for a vehicle, the apparatus comprising:
a processor; and
a memory storing at least one instruction that, when executed by the processor communicating with the memory, is configured to cause the apparatus to:
obtain a pedal sensor signal indicating a position of a clutch pedal of the vehicle,
obtain a gear sensor signal indicating whether a gear stage of the vehicle is in a reverse or neutral state,
obtain data indicating a speed and distance of a preceding vehicle,
based on the position of the clutch pedal of the vehicle, the gear stage of the vehicle, and the speed and distance of the preceding vehicle, determine a required acceleration or a required deceleration,
based on the determined required acceleration or the determined required deceleration, determine an engine torque value or a braking torque value, respectively,
output a signal indicating the determined engine torque value or a braking torque value, and
control, based on the signal, operation of the vehicle.

20. The apparatus according to claim 19, wherein the at least one instruction, when executed by the processor communicating with the memory, is configured to cause the apparatus to:
suspend, based on the clutch pedal being disengaged, the output of the signal indicating the determined engine torque value, and
resume, based on the clutch pedal being at least partially engaged, the output of the signal by increasing a torque value from zero or a reduced value up to the determined engine torque value.
